(19) United States
(12) Patent Application Publication
(10) Pub. No.: US 2009/0246606 A1
(43) Pub. Date: Oct. 1, 2009

(54) Electric power source used with vehicles

(76) Inventor: Hideo Shimizu, Kakogawa City (JP)

Correspondence Address: WENDEROTH, LIND & PONACK, L.L.P., 1030 15th Street, N.W.,, Suite 400 East, Washington, DC, 20005-1503, US

(21) Appl. No.: 12/382,791

(22) Filed: Mar. 24, 2009

(30) Foreign Application Priority Data
Mar. 27, 2008 (JP) 2008-84888

(51) Int. Cl. H01M 10/50

(52) U.S. Cl. 429/62

(57) ABSTRACT

An electric power source used with a vehicle includes: a battery block composed of a rechargeable battery; a cooling plate thermally coupled with the battery block to cool the battery; a cooling mechanism for cooling the cooling plate; and a controller for controlling the cooling mechanism to switch the cooling plate into a cooled state and an uncooled state. The controller controls the cooling mechanism both in accordance with temperature of the battery block and temperature of the cooling plate, and switches the cooling plate into the cooled state and the uncooled state.

### BACKGROUND OF THE INVENTION

1. Field of the Invention

The present invention generally relates to an electric power source being used with an electric vehicle such as a hybrid car, and particularly to an electric power source for cooling a battery block by means of a cooling plate.

2. Description of the Related Art

The electric power source to be mounted on a hybrid car or the like is required of forcibly cooling a battery which will generate heat when the battery is charged and discharged at a large current. This is because temperature increase of the battery causes electrical characteristics of the battery to decrease as well as shortens a duration of life of the battery and further causes safety to be inhibited. In order to prevent such harmful results, there have been developed a power source in which a battery is cooled by means of air (JP 2006-252847-A) and a power source in which a battery is cooled by means of a cooling plate (Japanese Utility Model Registration No. 2559719). The power source disclosed in JP 2006-252847-A forcibly blows air to cool the battery. This power source controls an air blow by detecting dew formation in order to prevent an adverse effect that dew is formed from moisture in the air to attach the battery.

The moisture (water vapor) in the air forms dew in relation between temperature and humidity. FIG. 1 is a graph showing a saturated amount of water vapor relative to temperature. As can be seen in the graph, when air temperature decreases, relative humidity rapidly increases even when an amount of moisture (an amount of water vapor) contained in the air remains unchanged. For example, the air at 10° C. can contain 9.4 g of moisture in 1 m³ of air, while the air at 0° C. contains 4.8 g which is a remarkably reduced amount of moisture that can be contained in 1 m³ of air. That is to say, when the air temperature decreases, the amount of moisture that can be contained in a gaseous state rapidly decreases. In view of this aspect, when the air temperature decreases, the amount of moisture that can be contained in the air decreases and the relative humidity increases, and thus the dew is formed when the relative humidity reaches the level of 100%.

In the case of the electric power source disclosed in JP 2006-252847-A, when the dew is formed, an operation of a fan is controlled in accordance with the battery temperature. When the dew is formed and the battery temperature is low, the fan stops its operation, and when the dew is formed and the battery temperature is high, the fan starts its operation. When the dew is formed and the fan stops its operation, the amount of dew formation does not increase, but disadvantageously a concentrated state lasts longer because the moisture formed into the dew cannot evaporate to be dried. Further, when the battery temperature is higher than preset temperature in a state of dew formation, the fan is in operation; in such a state, however, since the air is to be forcibly blown in a state of forming the dew, the moisture contained in the air being fed from time to time is formed to dew at a portion that is cooled by low temperature, resulting in an adverse effect that the dew formation gradually increases temporarily. However, when the battery temperature increases and the temperature of the blown air increases, the dew is not formed; but when there exists a local portion with lower temperature, such portion cannot be prevented from the dew formation. Therefore, the power source as described in JP 2006-252847 suffers a difficulty of efficiently cooling the battery while preventing the dew formation. In particular, since the battery is cooled by air with smaller specific heat, it is difficult to quickly cool the battery in a state where the heat value of the battery is large.

In the case of the power source disclosed in Japanese Utility Model No. 2559719, a cooling plate is cooled by means of a cooling pipe circulating a liquid, and the battery is cooled when the battery is placed on the cooling plate. In this cooling structure, air is not forcibly blown to cool the battery, but the battery is directly cooled by means of the cooling plate; so when the cooling plate is cooled to low temperature, the battery can be cooled efficiently and quickly. In particular, even when a cooling calorie is large for cooling the battery in a unit time period and the heat value of the battery is large, the battery can be quickly cooled. Further, since the air is not forcibly blown, the adverse effect can be reduced that dew-formed water increases when the moisture in the air is formed into dew from time to time. However, the cooling plate is required of being cooled to lower temperature in order to increase the cooling calorie of the battery. As can be seen in the characteristics shown in FIG. 1, the cooling plate being cooled to low temperature cannot prevent the dew from being formed on the plate surface because the amount of moisture in the air decreases. Particularly, the lower the surface temperature of the cooling plate, the easier the dew formation to occur as a result of the lowered temperature of the air in the vicinity of the plate surface. In view of this aspect, the power source in which the battery is directly cooled by means of the cooling plate suffers a difficulty that the dew formation on the surface of cooling plate is prevented while the battery is efficiently cooled.

The present invention has been made in order to overcome the above-mentioned drawbacks. It is a primary object of the present invention to provide an electric power source used with a vehicle, in which a battery can be quickly cooled in an ideal state while the moisture in the air is prevented from dew formation.

### SUMMARY OF THE INVENTION

The electric power source used with a vehicle includes: a battery block 2 composed of a rechargeable battery 1; a cooling plate 3 thermally coupled with the battery block 2 to cool the battery 1; a cooling mechanism 70 for cooling the cooling plate 3; and a controller 71 for controlling the cooling mechanism 70 to switch the cooling plate 3 into a cooled state and an uncooled state. The controller 71 controls the cooling mechanism 70 both in accordance with temperature of the battery block 2 and temperature of the cooling plate 3, and switches the cooling plate 3 into the cooled state and the uncooled state.

The above-described electric power source can cool the battery in an ideal state while preventing the moisture in the air from dew formation. Particularly, since the electric power source is so designed as to directly cool the battery by thermally coupling the battery block with the cooling plate instead of cooling the battery by blowing the air, the battery is quickly and efficiently cooled while the cooling plate can also be prevented from the dew formation. In particular, the electric power source of the present invention can control the cooling plate not to have the dew formation, by controlling the cooling mechanism in accordance with the temperature of the battery block and the temperature of the cooling plate instead of controlling by detecting that the dew has been formed. Therefore, the electric power source is distinctive in that the battery can be quickly and quietly cooled while the dew formation is prevented.

The electric power source used with a vehicle of the present invention can be so structured that the cooling mechanism 70 includes: a compressor 16 for pressurizing a gaseous refrigerant exhausted from the cooling plate 3; a condenser 15 for cooling and liquefying the refrigerant having been pressurized by the compressor 16; a receiver tank 18 for storing the liquid refrigerant having been liquefied by the condenser 15; and an expansion valve 14 composed of a flow regulating valve or capillary tube 14A for feeding the refrigerant in the receiver tank 18 to the cooling plate 3. The cooling mechanism 70 is adapted to cool the cooling plate 3 by means of evaporation heat generated when the refrigerant supplied from the expansion valve 14 is evaporated inside the cooling plate 3.

The electric power source can quickly cool the cooling plate by means of the cooling mechanism. Particularly, the evaporation heat of the refrigerant is very large and can cool the battery very efficiently and quickly when compared with a conventional structure that the air is blown to cool the battery. In particular, even when a load on the battery is very large and the battery temperature is rapidly elevated temporarily, the battery temperature can be quickly lowered. Further, the cooling mechanism can efficiently cool the battery block in a simplified structure when used in joint with the air-conditioning compressor and condenser mounted on a vehicle.

The electric power source used with a vehicle of the present invention can be so structured that the controller 71 includes: an on-off valve 17 connected to an inlet side of the cooling plate 3; a battery temperature sensor 72 for detecting temperature of the battery block 2; a plate temperature sensor 73 for detecting temperature of the cooling plate 3; and a control circuit 74 for controlling the on-off valve 17 in accordance with detectable temperature which is detected by means of the battery temperature sensor 72 and the plate temperature sensor 73. When the respective temperature detected by the battery temperature sensor 72 and the plate temperature sensor 73 is higher than respectively preset temperature, the controller 71 opens the on-off valve 17 to switch the cooling plate 3 to a cooled state.

In the above-described electric power source, when the cooling plate is connected in parallel via the on-off valve to an air conditioner composed of the compressor and condenser mounted on a vehicle, the cooling plate can be cooled by opening the on-off valve. Especially, in the case of vehicles available in recent years, since an air conditioner is constantly operated for dehumidification, it is not necessary to operate a compressor dedicated to cool the cooling plate, and the cooling plate can be cooled by the use of the air conditioner which is constantly operated.

In the case of the electric power source used with a vehicle of the present invention, the controller 71 has a heat value detection circuit 75 for detecting a heat value generated by the battery block 2, and when the heat value of the battery 1 that is detected by the heat value detection circuit 75 is larger than a preset value and when the temperature of the battery block 2 and the temperature of the cooling plate 3 are higher than respectively preset temperature, the cooling plate 3 can be switched to a cooled state.

Since the electric power source controls a cooled state of the cooling plate by detecting the heat value of the battery in addition to the temperature of the battery block and the temperature of the cooling plate, the dew formation can be prevented, and in addition the battery can be cooled in an ideal state of limiting a temperature elevation of the battery. Since heat is generated inside the battery and thus the temperature is elevated by such heat, there occurs a time delay from such heat generation till the elevation of the battery temperature. Especially, since the temperature sensor detecting the battery temperature detects the temperature produced on the battery surface, there occurs such time delay in detecting the elevation of temperature caused by an interior heat generation. Since the circuit for detecting a heat value detects an amount of heat generated by a charging and discharging current or the like, the heat elevation can be detected before the battery temperature is elevated. In view of this aspect, the temperature elevation of the battery can be reduced to minimum by cooling the battery in a manner that its temperature will not be elevated, instead of by cooling the battery with its temperature having been elevated.

The electric power source used with a vehicle of the present invention can be so structured that the heat value detection circuit 75 detects a heat value of the battery block 2 based on a current flowing through the battery block 2 and on a temperature difference between the inlet side and outlet side of the cooling plate 3. Such structure enables the detection of the battery heat value while a simplified structure is achieved.

The electric power source used with a vehicle of the present invention can be so structured that the controller 71 has a dew formation sensor 76 for detecting dew formed on the cooling plate 3 and that the dew formation sensor 76 detects the dew formed on the cooling plate 3, and thus the preset temperature of the plate temperature sensor 73 can be altered.

Since the electric power source is so designed as to alter the preset temperature by detecting the dew formation, the cooling plate can be cooled to such low temperature as may not form the dew. In view of this aspect, the battery block can be cooled more quickly while preventing the dew formation.

The electric power source used with a vehicle of the present invention can be so structured as to include: a battery block 2 composed of a rechargeable battery 1; a cooling plate 3, 80 thermally coupled to the battery block 2 to cool the battery 1; a cooling mechanism 70 for cooling the cooling plate 3, 80; and a controller 71 for controlling the cooling mechanism 70 to switch the cooling plate 3, 80 to a cooled state and an uncooled state. The cooling plate 3, 80 can be so structured as to incorporate a cooling pipe 13, 83 through which the refrigerant is circulated. The cooling pipe 13, 83 is composed of four or more rows of parallel pipes 13A, 83A interconnected in series and disposed inside the cooling plate 3, 80, and can be so structured that a parallel pipe 13Ab, 83Ab on the outlet side is disposed adjacent to a parallel pipe 13Aa, 83Aa on the inlet side.

The electric power source, with its cooling plate being of uniform temperature, can uniformly cool the battery of the battery block. This is made possible because the parallel pipe on the outlet side with the temperature being liable to be elevated is disposed adjacent to the parallel pipe with the lower temperature on the inlet side. The cooling pipe where a/the plurality of parallel pipes are cooled in a series connection is designed to cool the battery by means the refrigerant being flowed from the inlet side and to exhaust the refrigerant from the outlet side. The cooling plate supplies the refrigerant to the cooling pipe via the expansion valve such as the capillary tube. Supplied into the cooling pipe is a liquefied refrigerant. The refrigerant, when passing through the cooling pipe, is evaporated and fed to the outlet side. When the temperature of the cooling plate is high, the refrigerant supplied to the cooling pipe from the capillary tube which does not control a quantity of supply of the refrigerant may sometimes be fully evaporated en route. In such a state, the evaporated refrigerant but not the liquefied refrigerant is supplied to the parallel pipe on the outlet side, and thus the cooling effect by the evaporation heat becomes smaller. However, since the electric power source is so designed as to dispose the parallel pipe on the outlet side adjacent to the parallel pipe on the inlet side, the battery is efficiently cooled by the parallel pipe on the inlet side even if the cooling effect by the parallel pipe on the outlet side becomes smaller,. This is because the parallel pipe on the inlet side has a sufficient amount of liquefied refrigerant to effectively cool the battery.

The above and further objects of the present invention as well as the features thereof will become more apparent from the following detailed description to be made in conjunction with the accompanying drawings.

### BRIEF DESCRIPTION OF THE DRAWINGS

FIG. 1 is a graph showing a saturated amount of water vapor relative to the temperature;

FIG. 2 is a schematic, exploded, perspective view of the electric power source used with a vehicle in accordance with an embodiment of the present invention;

FIG. 3 is a bottom perspective view of the electric power source used with a vehicle in accordance with an embodiment of the present invention;

FIG. 4 is an enlarged, cross-sectional, perspective view showing the major portion of the electric power source used with a vehicle as shown in FIG. 2;

FIG. 5 is a partially enlarged, cross-sectional view taken along line V-V of the electric power source used with a vehicle as shown in FIG. 3;

FIG. 6 is a top plan view showing an example of the cooling pipe disposed in the cooling plate;

FIG. 7 is a top plan view showing an alternative example of the cooling pipe disposed in the cooling plate;

FIG. 8 is a flow chart showing that the control circuit controls the on-off valve; and

FIG. 9 is a perspective view of the battery block.

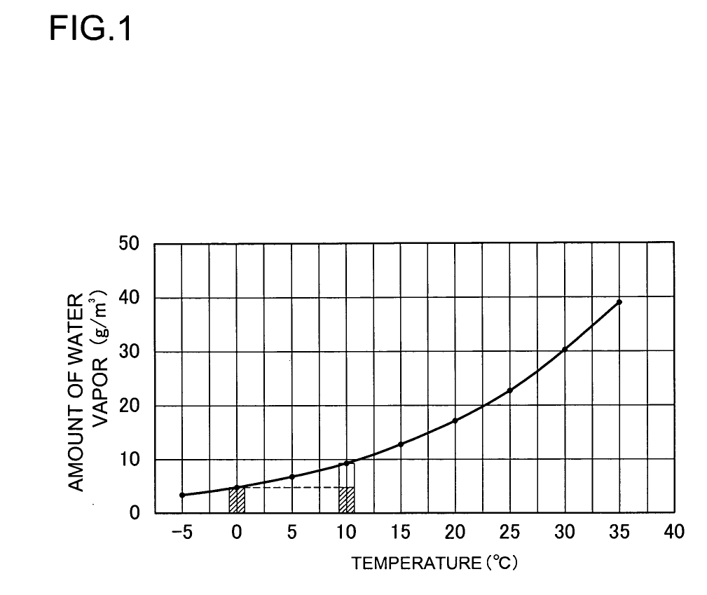

### DETAILED DESCRIPTION OF THE EMBODIMENT(S)

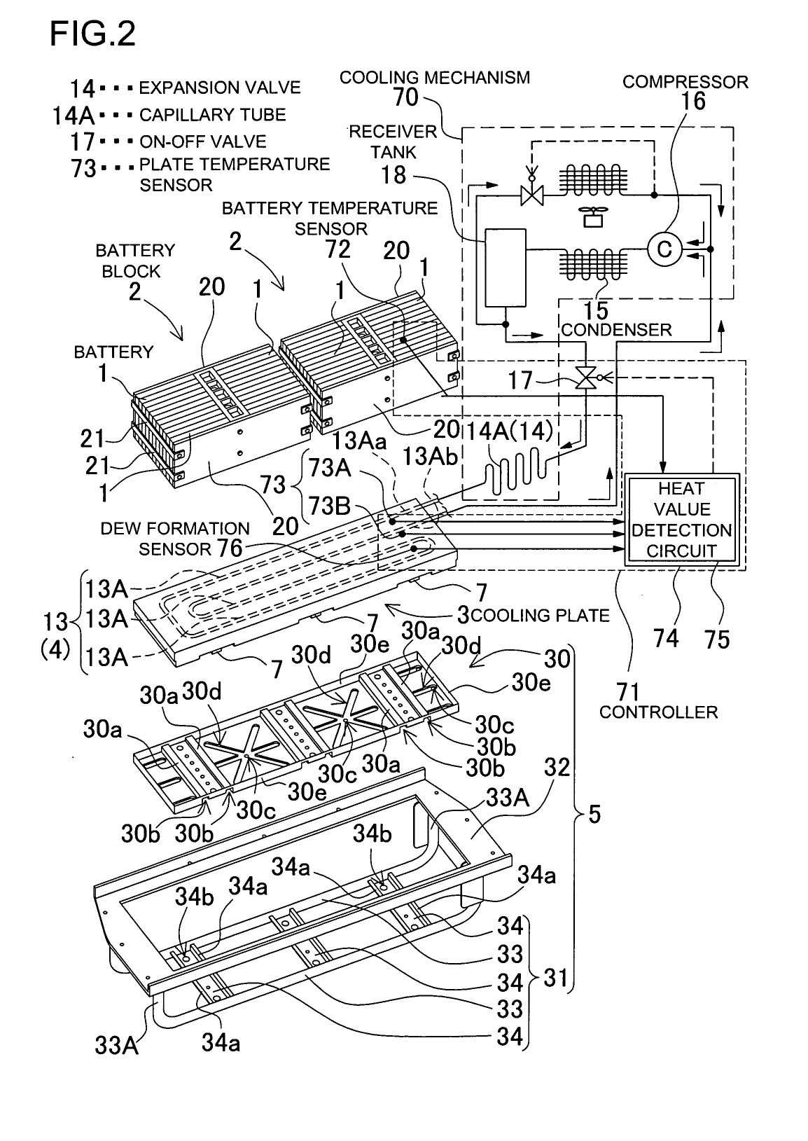

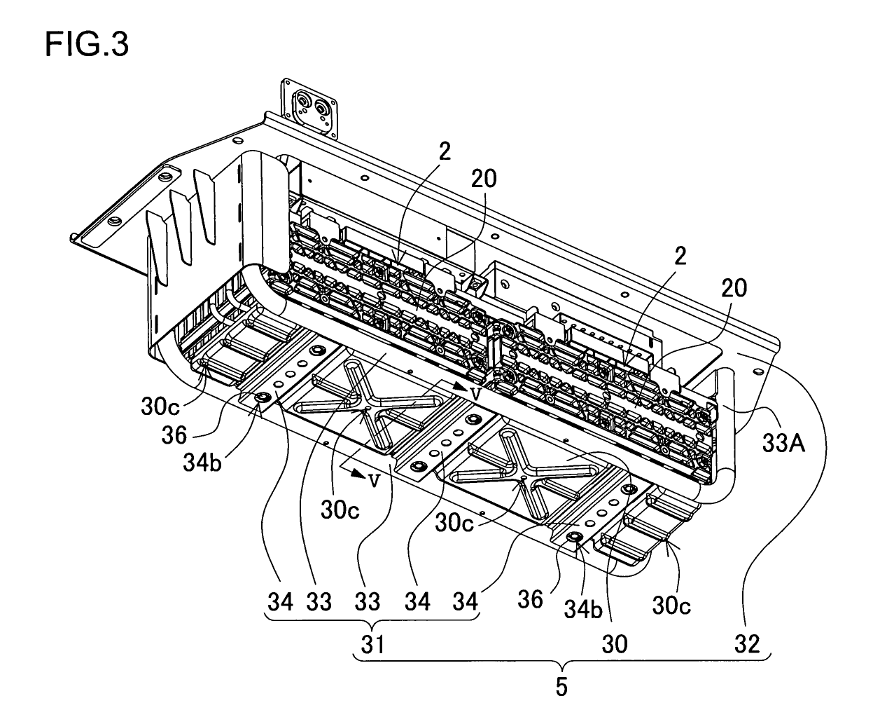

FIG. 2 through FIG. 5 show an electric power source used with a vehicle. FIG. 3 through FIG. 5 show a detail view of the electric power source illustrated in a schematic, exploded, perspective view in FIG. 2. The electric power source shown in these drawings includes: a battery block 2 composed of a rechargeable battery 1; a cooling plate 3 thermally coupled with and cooling the battery block 2; a cooling mechanism 70 for cooling the cooling plate 3; a controller 71 for controlling the cooling mechanism 70 to switch the cooling plate 3 into a cooled state and an uncooled state; and a frame structure 5 to which the cooling plate 3 is fixed. The electric power source forcibly cools the battery block 2 from a bottom face of the battery block by means of the cooling plate 3.

In regard to the cooling plate 3, a top surface plate 11 and a bottom plate 12 are interconnected at a periphery to define an interior portion as a sealed chamber 10. Incorporated in the sealed chamber 10 is a cooling pipe 13 serving as a heat exchanger 4 and being made of copper, aluminum or the like for circulating a liquefied refrigerant. The cooling pipe 13 is fixed in close contact with the top surface plate 11 of the cooling plate 3 to cool the top surface plate 11, and a thermal insulator (not shown) is disposed in a space defined with respect to the bottom plate 12 to thermally insulate the space defined with respect to the bottom plate 12.

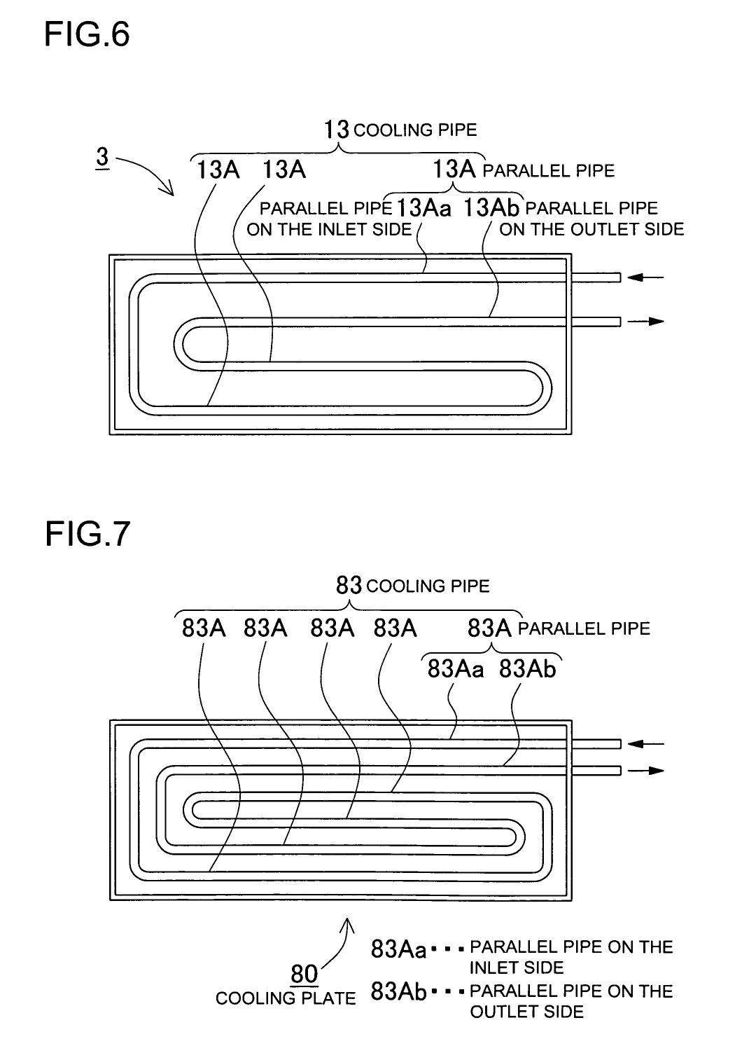

The cooling plate 3 shown in FIG. 6 cools the top surface plate 11 by evaporation heat generated when a supplied liquid refrigerant is evaporated inside the cooling pipe 13. The cooling pipe 13 is composed of four rows of parallel pipes 13A being interconnected in series and being disposed inside the cooling plate 3, and a parallel pipe 13Ab on the outlet side is disposed adjacent to a parallel pipe 13Aa on the inlet side. In the illustrated cooling plate 3, the four rows of parallel pipes 13A are interconnected in series to make up the cooling pipe 13; but six rows of parallel pipes 83A can also be interconnected in series as shown in FIG. 7 illustrating an alternative cooling plate 80. In the cooling plate 80 as well, a parallel pipe 83Ab on the outlet side is disposed adjacent to a parallel pipe 83Aa on the inlet side, with parallel pipes 83A on the inlet and outlet sides being disposed adjacent to each other. These cooling plates 3, 80 allow the refrigerant supplied from the parallel pipes 13Aa, 83Aa on the inlet side to be exhausted outwardly from the parallel pipes 13Ab, 83Ab on the outlet side. A liquefied refrigerant is supplied to the parallel pipes 13Aa, 83Aa on the inlet side. Since a sufficient amount of such refrigerant is supplied, the parallel pipes 13Aa, 83Aa on the inlet side are sufficiently cooled by the evaporation heat generated by the refrigerant. On the other hand, the refrigerant, while being evaporated inside the cooling pipes 13, 83, is supplied to the parallel pipes 13Ab, 83Ab on the outlet side, and so it may occur that most of the refrigerant has already been evaporated, resulting in a reduced amount of liquefied refrigerant.

Especially, when compared with an expansion valve being composed of a flow regulating valve for regulating a gate opening by detecting temperature on an outlet side of a cooling pipe, an expansion valve 14 made of a capillary tube 14A being composed of minute tubes of a given length maintains a generally constant flow rate of the refrigerant supplied to the cooling pipe 13 regardless of the temperature of the cooling plate 3. When the temperature of the cooling plate 3 reaches a considerably high level, it may occur that the refrigerant transmitted to the parallel pipe 13Ab on the outlet side has been evaporated en route, resulting in a reduced amount of liquid refrigerant on the outlet side. In such a state, since the amount of refrigerant being evaporated inside the parallel pipe 13Ab on the outlet side becomes smaller, a cooling calorie provided by the parallel pipe 13Ab on the outlet side becomes smaller. This is because the evaporation heat generated by the refrigerant serves as the cooling calorie. However, in the case of the cooling plate 3 in which the parallel pipe 13Aa on the inlet side is disposed in the vicinity of the parallel pipe 13Ab on the outlet side, the cooling calorie provided by the parallel pipe 13Aa on the inlet side is large. Even if the cooling calorie provided by the parallel pipe 13Ab on the outlet side becomes smaller, a uniform cooling operation becomes possible by both of the cooling calories because the cooling calorie provided by the parallel pipe 13Aa on the inlet side is large.

The cooling pipe 13 is connected via an on-off valve 17 to the cooling mechanism 70 cooling the cooling plate 3. The cooling mechanism 70 shown in FIG. 2 includes: a compressor 16 for pressurizing a gaseous refrigerant exhausted from the cooling plate 3; a condenser 15 for cooling and liquefying the refrigerant having been pressurized by the compressor 16; a receiver tank 18 for storing the refrigerant having been liquefied by the condenser 15; and an expansion valve 14 composed of the flow regulating valve or capillary tube 14A for feeding the refrigerant contained in the receiver tank 18 to the cooling plate 3. The cooling mechanism 70 cools the cooling plate 3 by means of the evaporation heat generated when the refrigerant supplied from the expansion valve 14 is evaporated inside the cooling plate 3.

The expansion valve 14 shown in FIG. 2 is made of the capillary tube 14A being composed of minute tubes for narrowing down a flow rate of the refrigerant, a function of which is to limit an amount of refrigerant to be supplied to the cooling pipe 13 and then to expand the refrigerant under a thermal insulation. The expansion valve 14 made of the capillary tube 14A limits an amount of supplying the refrigerant to a quantity of exhausting the refrigerant in a gaseous state after the refrigerant has fully been evaporated in the cooling pipe 13 of the cooling plate 3. The condenser 15 cools and liquefies the gaseous refrigerant supplied from the compressor 16. Since the condenser 15 dissipates the heat of the refrigerant and liquefies the refrigerant, the condenser 15 is disposed in front of a radiator mounted to a vehicle. The compressor 16 is driven by an engine or a motor of the vehicle, pressurizes the gaseous refrigerant exhausted from the cooling pipe 13, and such pressurized refrigerant is supplied to the condenser 15. To add an explanation about the cooling mechanism 70, the refrigerant having been pressurized by the compressor 16 is cooled and liquefied by the condenser 15, such liquefied refrigerant is stored in the receiver tank 18, the refrigerant contained in the receiver tank 18 is supplied to the cooling plate 3, and the top surface plate 11 of the cooling plate 3 is cooled by the evaporation heat generated when the refrigerant is evaporated inside the cooling pipe 13 of the cooling plate 3.

An explanation shall be made concerning the cooling mechanism 70 shown in FIG. 2. The compressor 16, the condenser 15 and the receiver tank 18 mounted to a vehicle for cooling inside the vehicle are concomitantly utilized as the mechanism for cooling the battery block 2. Such structure enables the battery block 2 mounted to the vehicle to be efficiently cooled without providing an additional cooling mechanism dedicated for cooling the battery block 2. In particular, the cooling calorie required for cooling the battery block 2 is very small as compared with a cooling calorie required for cooling inside the vehicle. In view of this aspect, even when the cooling mechanism for cooling inside the vehicle is concomitantly utilized for cooling the battery block 2, the battery block 2 can be effectively cooled with a capacity of cooling inside the vehicle being hardly reduced.

The controller 71 for controlling to cool the cooling plate 3 includes: an on-off valve 17 having the inlet side of the cooling plate 3 connected to the receiver tank 18; a battery temperature sensor 72 for detecting temperature of the battery block 2; a plate temperature sensor 73 for detecting temperature of the cooling plate 3; and a control circuit 74 for controlling the on-off valve 17 in accordance with detectable temperature to be detected respectively by the battery temperature sensor 72 and the plate temperature sensor 73. When the temperature detected respectively by the battery temperature sensor 72 and the plate temperature sensor 73 is higher than respectively preset temperature, the on-off valve 17 is opened by the controller 71, the refrigerant is supplied to the cooling plate 3, and the cooling plate 3 is switched to a cooled state.

The on-off valve 17 is opened by the control circuit 74 and controls a cooled state of the cooling plate 3. When the on-off valve 17 is opened, the cooling plate 3 is put in the cooled state. When the on-off valve 17 is opened, the refrigerant contained in the receiver tank 18 is supplied to the cooling plate 3 via the expansion valve 14. The refrigerant supplied to the cooling plate 3 cools the cooling plate 3 by the evaporation heat generated when the refrigerant is evaporated inside the cooling plate 3. The refrigerant having been evaporated after cooling the cooling plate 3 is absorbed into the compressor 16 and then is circulated from the condenser 15 to the receiver tank 18. When the on-off valve 17 is closed, the refrigerant is not circulated into the cooling plate 3, and the cooling plate 3 is put in an uncooled state.

The plate temperature sensor 73 includes: a plate temperature sensor 73A on the inlet side for detecting inlet-side temperature of the refrigerant circulated into the cooling plate 3; and a plate temperature sensor 73B on the outlet side for detecting outlet-side temperature of the refrigerant. The controller 71 shown in FIG. 2 has the control circuit 74 provided with a heat value detection circuit 75 for detecting a heat value of the battery 1 in accordance with a temperature difference detected in the cooling plate 3 by the plate temperature sensor 73A on the inlet side and the plate temperature sensor 73B on the outlet side, in a state that the on-off valve 17 is opened. This is possible because when the heat value of the battery 1 increases, the temperature difference appearing on the inlet side and the outlet side becomes larger. The control circuit can also calculate the heat value of the battery in accordance with an integrated value of a current during a prescribed time period of being charged to and discharged from the battery. The control circuit calculates the heat value of the battery in accordance with the integrated value of the current, for example, during 10 minutes. This is possible because when the integrated value of the current of the battery increases, the heat value becomes larger.

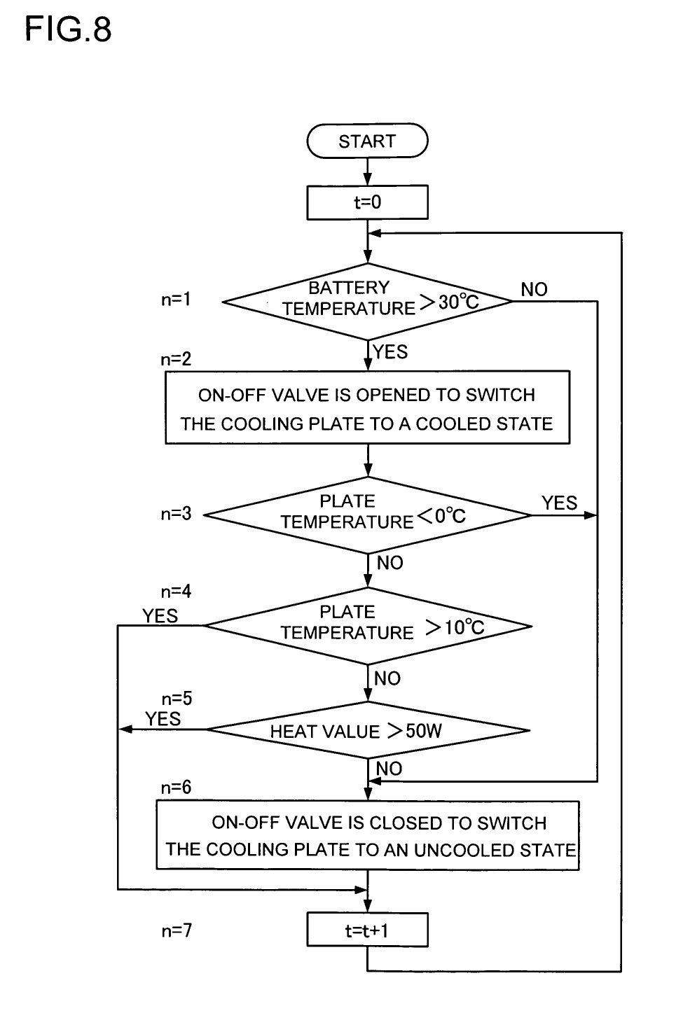

FIG. 8 is a flow chart showing that the control circuit 74 controls the on-off valve 17. As can be seen in this flow chart, the on-off valve 17 is controlled to cool the battery block 2 in the following steps.

First, a counter function of a timer is set at t=0, and then in subsequent steps the on-off valve 17 is controlled to switch the cooling plate 3 to a cooled state and an uncooled state.

(Step: n=1 and 2)

A battery temperature is detected by means of the battery temperature sensor 72, and such detected temperature is compared with a preset temperature of 30° C. When the battery temperature is higher than the preset temperature of 30° C., the on-off valve 17 is opened and the refrigerant is supplied to the cooling plate 3 to cool the cooling plate 3. When the battery temperature is lower than or equal to the preset temperature of 30° C., a step is advanced to n=6, where the on-off valve 17 is closed to switch the cooling plate 3 to an uncooled state.

(Step: n=3)

Temperature of the cooling plate 3 is detected by means of the plate temperature sensor 73, and such detected temperature of the cooling plate 3 is compared with a first preset temperature of 0° C. The temperature of the cooling plate 3 can be detected by means of the plate temperature sensor 73A on the inlet side and the plate temperature sensor 73B on the outlet side. The temperature of the cooling plate 3 shall be, for example, an average value obtained from the plate temperature sensor 73A on the inlet side and the plate temperature sensor 73B on the outlet side, or alternatively may be temperature detected by means of the plate temperature sensor 73B on the outlet side. It should be noted, however, that another temperature sensor (not shown) may be provided in the middle of the plate temperature sensor on the inlet side and the plate temperature sensor on the outlet side to thus detect the temperature of the cooling plate by means of such intermediate plate temperature sensor.

When the temperature of the cooling plate 3 is lower than the first preset temperature of 0° C., a step is advanced to n=6, where the on-off valve 17 is closed to switch the cooling plate 3 to an uncooled state. When the temperature of the cooling plate 3 is not lower than 0° C., namely 0° C. or higher, a step is advanced to n=4.

(Step: n=4)

When the temperature of the cooling plate 3 is 0° C. or higher, the temperature of the cooling plate 3 is compared with a second preset temperature of 10° C., in this step. When the temperature of the cooling plate 3 is higher than the preset temperature of 10° C., the cooling plate 3 is maintained in a cooled state without closing the on-off valve 17 and a step is advanced to n=7. When the temperature of the cooling plate 3 is not higher than 10° C., namely 10° C. or lower, a step is advanced to n=5.

(Step: n=5)

When the temperature of the cooling plate 3 is 10° C. or lower, the heat value of the battery 1 is compared with a preset value of 50 W, in this step. When the heat value of the battery 1 is larger than the preset value of 50 W, the cooling plate 3 is maintained in a cooled state without closing the on-off valve 17 and a step is advanced to n=7. When the heat value of the battery 1 is not larger than the preset value of 50 W, namely 50 W or smaller, a step is advanced to n=6.

(Step: n=6)

In this step, the on-off valve 17 is closed to switch the cooling plate 3 to the uncooled state.

(Step: n=7)

In this step, the counter function of the timer is set at t=t+1, and a step is looped back to n=1.

In the above-described control circuit 74, when the temperature of the battery 1 is higher than 30° C., the on-off valve 17 is opened to cool the battery 1 by means of the cooling plate 3. However, when the temperature of the cooling plate 3 is lower than 0° C., the on-off valve 17 is closed to switch the cooling plate 3 to an uncooled state even if the temperature of the battery 1 is higher than 30° C., and thus the cooling plate 3 is prevented from the dew formation. That is to say, when the temperature of the cooling plate 3 is lower than 0° C., a cooling operation of the cooling plate 3 is stopped regardless of the temperature of the battery 1 and the heat value of the battery 1. This is because when the temperature of the cooling plate 3 is lower than 0° C., the battery 1 can be cooled even if the cooling plate 3 is not cooled by means of the refrigerant, and in such state, when the cooling plate 3 is cooled by means of the refrigerant to even lower temperature, dew is likely to be formed.

In a state that the temperature of the battery 1 is higher than the preset temperature of 30° C. and that the temperature of the cooling plate 3 is 0° C. or higher, only when the temperature of the cooling plate 3 is higher than 10° C. or the heat value of the battery 1 is larger than the preset value of 50 W, the on-off valve 17 is opened to switch the cooling plate 3 to a cooled state. In a state that the heat value of the battery 1 is so small as to be smaller than the preset value of 50 W, only when the temperature of the cooling plate 3 is higher than 10° C., the on-off valve 17 is opened to switch the cooling plate 3 to a cooled state. When the temperature of the cooling plate 3 is in a range of from 0° C. to 10° C., the temperature of the cooling plate 3 is so low that dew is likely to be formed. In such state, only when the heat value of the battery 1 is equal to or larger than the preset value of 50 W, the on-off valve 17 is opened to switch the cooling plate 3 to a cooled state. When the heat value of the battery 1 is large, a decrease in temperature of the cooling plate 3 is so small that the dew is in a limited ease of formation. In a state that the cooling plate 3 is in a temperature range of from 0° C. to 10° C., only when the heat value of the battery 1 is larger than the preset value, the cooling plate 3 is cooled by means of the refrigerant. That is to say, only when the temperature of the cooling plate 3 is in the range of from 0° C. to 10° C. and when the heat value of the battery 1 is equal to or smaller than the preset value of 50 W, the on-off valve 17 is closed to switch the cooling plate 3 to an uncooled state, and thus the cooling plate 3 is prevented from the dew formation.

Further, in the above-described flow chart, the first preset temperature is set to be 0° C. for switching the cooling plate 3 to a cooled state and an uncooled state, and the second preset temperature is set to be 10° C. However, the controller 71 as shown in FIG. 2 has a dew formation sensor 76 for detecting the dew formed on the cooling plate 3. When the dew formation is detected on the cooling plate 3 by means of the dew formation sensor 76, the preset temperature of the plate temperature sensor 73 can also be altered. In the controller 71 in the above-described flow chart, since the first preset temperature is set to be 0° C. for switching the cooling plate 3 to a cooled state and an uncooled state, the cooling plate 3 is forcibly cooled by means of the refrigerant even in a range of 0° C. or more when the heat value of the battery 1 exceeds 50 W. In such state, when the dew formation sensor 76 detects the dew formation, the first preset temperature is altered to be higher than 0° C. In such case, the first preset temperature is gradually raised according to a prescribed step and is altered to a higher level where the dew is not formed. After the first preset temperature is altered to a higher level by means of a signal from the dew formation sensor 76, the dew formation sensor 76 detects the dew formation at a prescribed timing. When the dew formation is not detected, the first preset temperature is gradually lowered to the initially set temperature, and when the dew formation is detected, the first preset temperature is altered to higher temperature where the dew is not formed.

Further, the second preset temperature too can be altered by means of the dew formation sensor 76. When the heat value of the battery 1 exceeds 50 W at temperature equal to or lower than the second preset temperature of 10° C., the cooling plate 3 is cooled by means of the refrigerant. In such state, when the dew formation sensor 76 detects dew formation, the second preset temperature is raised according to a prescribed step to reach temperature where the dew is not formed. For example, in a state that the heat value of the battery 1 is larger than 50 W and the cooling plate 3 is cooled by means of the refrigerant, when dew is formed at the temperature of the cooling plate 3 being lower than 15° C. and when dew is not formed at the temperature equal to or higher than 15° C., the second preset temperature is altered to 15° C. In such case too, after the second preset temperature is altered to be higher by means of a signal from the dew formation sensor 76, the dew formation is detected by the dew formation sensor 76 at a prescribed timing. When the dew formation is not detected, the second preset temperature is gradually lowered to the initially set temperature; and when the dew formation is detected, the second preset temperature is altered to high temperature where the dew is not formed.

Since the above-described control circuit 74 is so designed that the cooled state and the uncooled state are controlled in accordance with the first preset temperature and the second preset temperature of the cooling plate 3 and also in accordance with the heat value of the battery 1 and that the dew formation sensor 76 detects the dew formation and alters the respectively preset temperature, the battery 1 can be cooled more efficiently and quickly while the cooling plate 3 is prevented from the dew formation. As a matter of course, the electric power source of the present invention can also be so constructed and arranged that the temperature of the cooling plate is compared with a single point of preset temperature and that when the temperature of the cooling plate is higher than such preset temperature, the cooling plate is cooled, and when the temperature of the cooling plate is lower than the preset temperature, the cooling plate is controlled not to be cooled.

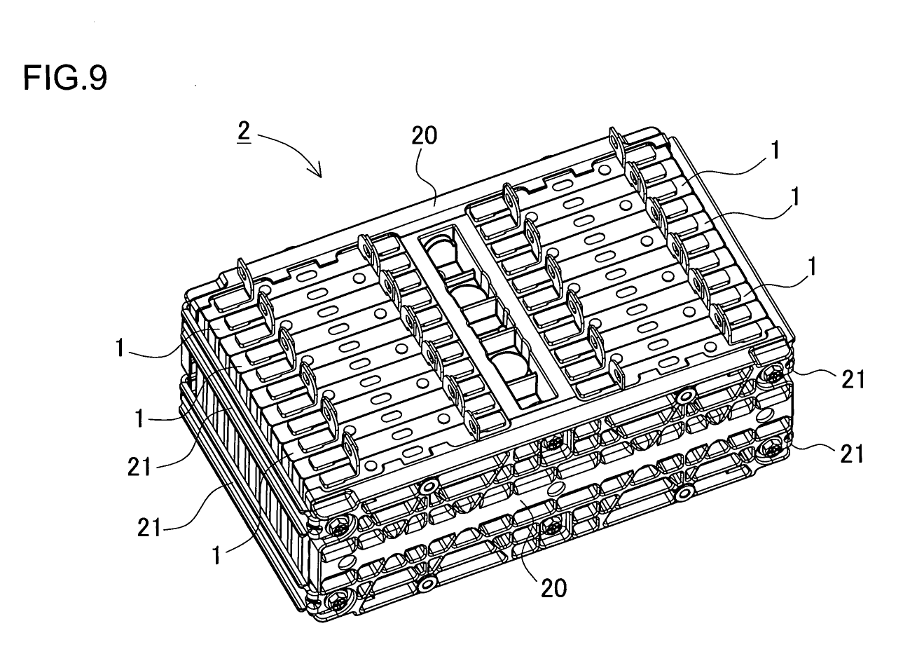

In the electric power source shown in FIG. 2 and FIG. 3, the cooling plate 3 is of an elongated rectangle, on which two groups of battery blocks 2 are fixedly disposed in a side-to-side configuration. The battery block 2 is shown in a perspective view in FIG. 9. In the battery block 2, a plurality of prismatic batteries 1 in a vertical posture are layered on a horizontal plane in two rows, with the bottom surface being planar. The prismatic batteries 1 are interconnected in series via a bus bar (not shown) made of a metallic plate. Further, in the battery blocks 2, the opposed end faces of the layered batteries 1 are interposed between a pair of end plates 20, with the batteries 1 being fixed in a layered state. The pair of end plates 20 have their opposed ends interconnected by means of metallic connection fixtures 21 to fix the layered batteries 1.

The battery blocks 2 are fixed on a top face of the cooling plate 3, with each of prismatic batteries 1 being fixed in close contact with respect to each other. The prismatic battery 1 has its outer container made of metal such as aluminum. The metallic container is of high thermal conductivity, and when the bottom face is fixed in close contact with the top surface of the cooling plate 3, the entire container can be uniformly cooled from the bottom face. The prismatic battery 1 is a lithium-ion battery. It should be noted, however, that the battery can be any kind of rechargeable battery such as a nickel-hydrogen battery instead of the lithium-ion battery.

The cooling plate 3 has an insulation gap 6 and a fixture protrusion 7 on a face opposite to the frame structure 5, the cooling plate 3 is fixed to the frame structure 5 via the fixture protrusion 7, and the cooling plate 3 and the frame structure 5 are thermally insulated by the insulation gap 6. In the electric power source shown in FIG. 2, three rows of elongated fixture protrusions 7 are provided on the bottom surface of the cooling plate 3, and the fixture protrusion 7 is fixed to a base plate 30 of the frame structure 5. The fixture protrusion can have a metallic rod of a square cross section fixed to the bottom face of the cooling plate 3, and a bottom plate of the cooling plate 3 can be provided by a press work so as to form a fixture protrusion. The illustrated electric power source has the fixture protrusion 7 on the cooling plate 3, but the electric power source can also be so designed that instead of being provided on the cooling plate 3, the fixture protrusion is provided to the frame structure so as to be fixed to the cooling plate 3 and that the cooling plate 3 is fixed to the frame structure in a manner of defining the insulation gap.

The frame structure 5 shown in FIG. 2 includes a base plate 30 for fixing the cooling plate 3 on the top surface of the base plate 30, a laddered frame 31 to which the base plate 30 is fixed, and a chassis frame 32 to which the laddered frame 31 is fixed.

The base plate 30 is fabricated by press-working a metal plate such as iron and an iron alloy, or alternatively such as aluminum and an aluminum alloy. Fixed on the top face of the base plate 30 are a plurality of rows (three rows in FIG. 2) of fixture protrusions 7 provided on the bottom face of the cooling plate 3. Further, the base plate 30 has a drain outlet 30c defined to vertically extend through the base plate 30, and the base plate 30 is press-worked into a shape of having a declivous drainage channel 30d running toward the drain outlet 30c. The base plate 30 thus shaped enables a liquid such as an electrolytic solution falling from the cooling plate 3 to be exhausted outwardly from the drain outlet 30c, while a bending strength of the base plate 30 is improved by a surrounding wall 30e at the periphery and by a grooving work for providing a drainage channel 30d.

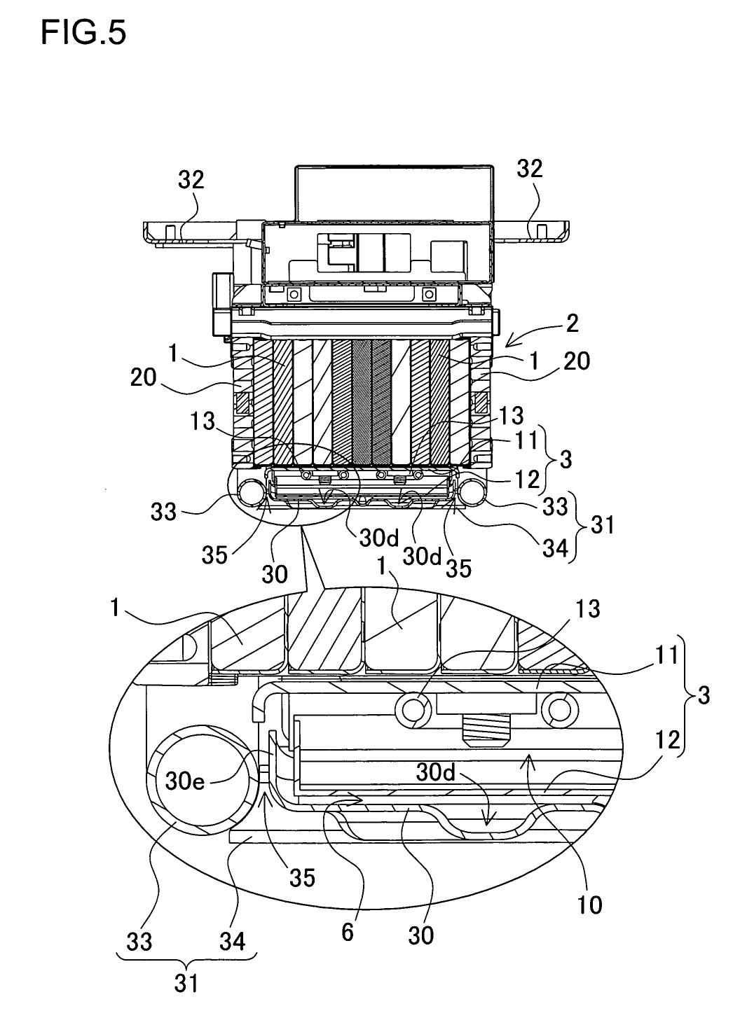

As shown in a partially enlarged view in FIG. 5, the base plate 30 has its width being narrower than a distance between hanger frames 33 and is so shaped that the opposite sides of the base plate 30 do not contact the hanger frames 33 and that an out-of-contact gap 35 is defined with respect to the hanger frame 33. The base plate 30, having the out-of-contact gap 35 defined with respect to the hanger frame 33, limits a thermal conduction toward the hanger frame 33. The base plate 30 is not directly connected to the hanger frame 33 but is connected via a mounting frame 34 to the hanger frame 33.

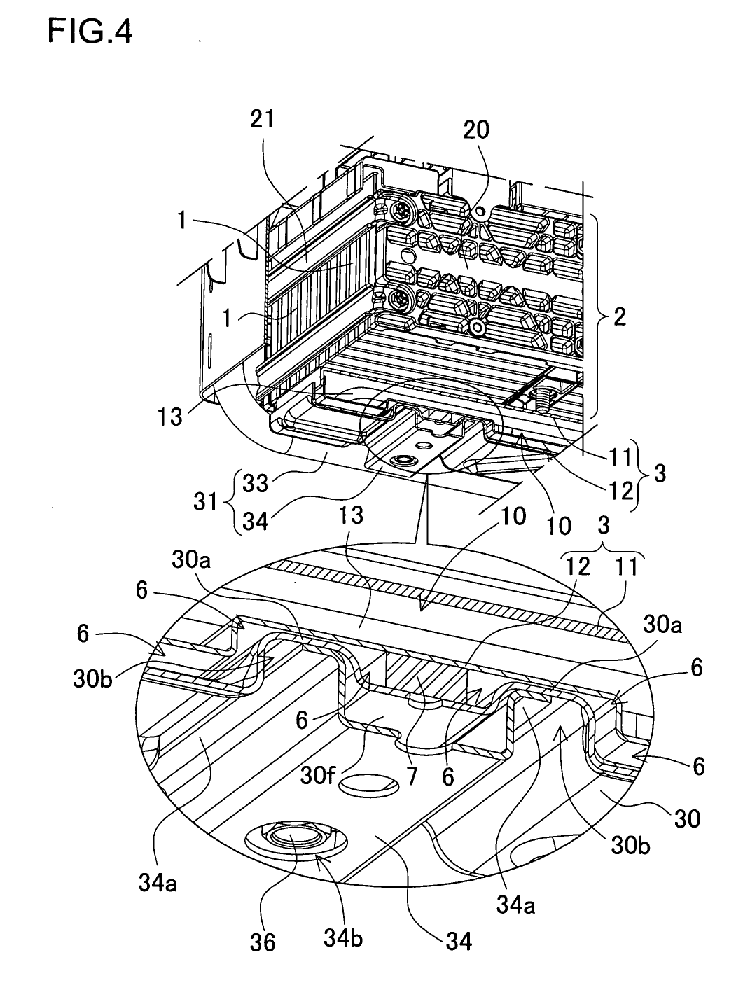

FIG. 4 shows a portion where the cooling plate 3 is fixed to the base plate 30. The illustrated base plate 30 has a reinforcement rib 30a projecting upwardly respectively on opposite sides of the fixture protrusion 7 provided on the bottom face of the cooling plate 3, and the fixture protrusion 7 is fixed between a pair of reinforcement ribs 30a. Such fixing structure enables a fixture portion 30f of the fixture protrusion 7 to be reinforced by the reinforcement rib 30a and fixed to the base plate 30. Therefore, the base plate 30 can improve strength required of the fixture portion 30f to fix the fixture protrusion 7. As shown in FIG. 4, the reinforcement rib 30a, having its top surface in a height away from the cooling plate 3, can reduce a thermal conduction from the cooling plate 3, and the reinforcement rib 30a allows the top surface to contact the bottom face of the cooling plate 3, so that the strength of the base plate can be improved for supporting the cooling plate 3.

The base plate 30, being of an elongated rectangle which is larger than the contour of the contour of the cooling plate 3, has the surrounding wall 30e at the periphery. The base plate 30 in a shape of the elongated rectangle has three rows of fixture protrusions 7 fixed on the opposite ends and in the middle portion. The fixture protrusion 7 is fixed to the base plate 30 in a posture orthogonal to a longitudinal direction of the elongated base plate 30.

The laddered frame 31 includes: a plurality of rows of mounting frames 34 to which the base plate 30 is fixed; and a hanger frames 33 to which opposite ends of the mounting frame 34 are respectively fixed. The illustrated laddered frame 31 connects three rows of mounting frames 34 to the hanger frames 33. The mounting frame 34 has its opposite ends fixed to the hanger frames 33 by a method such as welding. The mounting frame 34, being disposed to match with a position of the fixture protrusion 7 (namely, the fixture protrusion 7 being disposed to match with a position of the mounting frame 34), fixes the cooling plate 3 to the base plate 30 to match with a position of the mounting frame 34. Therefore, the mounting frame 34 is fixed to the hanger frame 33 on the opposite ends and middle portion of the hanger frame 33. The mounting frame 34 is fabricated by press-working a metal plate into a groove form and has a bent piece 34a located respectively at the opposite sides of the mounting frame 34 and bent outwardly along an opening edge of the groove. The bent piece 34a is guided to a ribbed groove 30b defined on the bottom face of the reinforcement rib 30a and is fixedly welded to the base plate 30.

The mounting frame 34 fabricated by press-working the metal plate into the groove form is in contact with and fixed to the base plate 30 by the bent piece 34a alone, and a portion between the opposite bent pieces 34a is spaced apart downwardly from the base plate 30, being out of contact. In view of this aspect, the mounting frame 34 of the groove form has a depth of the groove to be deeper than a projecting height of the reinforcement rib 30a. The mounting frame 34 thus structured can limit to reduced thermal conduction with respect to the base plate 30 by narrowing an area in contact with the base plate 30. Further, since a bottom face of the reinforcement rib 30a of the base plate 30 is supported by the opposite bent pieces 34a, the mounting frame 34 is distinctive in that the base plate 30 can be securely and firmly supported.

The mounting frame 34 has a through hole 34b defined for a set screw 36 to be inserted through for fixing the fixture protrusion 7 to the base plate 30. The through hole 34b, being diametrically larger than a screw head of the set screw 36, is adapted to allow the screw head into the through hole 34b, thus enabling the screw head to be rotated inside the through hole 34b. The set screw 36 is extended through the base plate 30, is threaded into an internally threaded hole (not shown) provided to the fixture protrusion 7, and fixes the base plate 30 to the cooling plate 3.

The hanger frame 33 is composed of two pieces of metal pipes which are formed into a shape of having a respective hanger portion 33A extending upwardly at opposite ends, and a top end of the hanger portion 33A is fixed to a chassis frame 32 to be fixedly welded to a vehicle. The illustrated laddered frame 31 has the two pieces of hanger frames 33 disposed at a width of enabling the opposite ends of the mounting frame 34 to be fixed, and fixes the opposite ends to the chassis frame 32.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2008-84888 filed in Japan on Mar. 27, 2008, the content of which is incorporated herein by reference.

1. An electric power source used with a vehicle, comprising:
a battery block composed of a rechargeable battery;
a cooling plate thermally coupled with the battery block to cool the battery;
a cooling mechanism for cooling the cooling plate; and
a controller for controlling the cooling mechanism to switch the cooling plate into a cooled state and an uncooled state,
wherein the controller controls the cooling mechanism both in accordance with temperature of the battery block and temperature of the cooling plate, and switches the cooling plate into the cooled state and the uncooled state.

2. The electric power source used with a vehicle as recited in claim 1, wherein the cooling mechanism comprises:
a compressor for pressurizing a gaseous refrigerant exhausted from the cooling plate; a condenser for cooling and liquefying the refrigerant having been pressurized by the compressor;
a receiver tank for storing the liquid refrigerant having been liquefied by the condenser; and
an expansion valve composed of a flow regulating valve or capillary tube for feeding the refrigerant in the receiver tank to the cooling plate,
wherein the cooling plate is cooled by means of evaporation heat generated when the refrigerant supplied from the expansion valve is evaporated inside the cooling plate.

3. The electric power source used with a vehicle as recited in claim 2, wherein the controller comprises:
an on-off valve connected to an inlet side of the cooling plate;
a battery temperature sensor for detecting temperature of the battery block;
a plate temperature sensor for detecting temperature of the cooling plate; and
a control circuit for controlling the on-off valve in accordance with detectable temperature which is detected by means of the battery temperature sensor and the plate temperature sensor,
wherein when the respective temperature detected by the battery temperature sensor and the plate temperature sensor is higher than respectively preset temperature, the control circuit opens the on-off valve to switch the cooling plate to a cooled state.

4. The electric power source used with a vehicle as recited in claim 3, wherein the plate temperature sensor comprises: a plate temperature sensor on the inlet side; and a plate temperature sensor on the outlet side.

5. The electric power source used with a vehicle as recited in claim 4, wherein the plate temperature sensor detects temperature of the cooling plate based on an average value obtained from the plate temperature sensor on the inlet side and the plate temperature sensor on the outlet side.

6. The electric power source used with a vehicle as recited in claim 4, wherein the plate temperature sensor determines that the temperature detected by the plate temperature sensor on the outlet side is temperature of the cooling plate.

7. The electric power source used with a vehicle as recited in claim 1, wherein the controller has a heat value detection circuit for detecting a heat value generated by the battery block, and when the heat value of the battery detected by the heat value detection circuit is larger than a preset value and when the temperature of the battery block and the temperature of the cooling plate are higher than respectively preset temperature, the cooling plate is switched to a cooled state.

8. The electric power source used with a vehicle as recited in claim 7, wherein in a state that the temperature of the cooling plate detected by the plate temperature sensor is higher than first preset temperature and lower than second preset temperature, when a heat value of the battery detected by the heat value detection circuit is larger than a preset value and when temperature of the battery block is higher than preset temperature, the controller switches the cooling plate to a cooled state.

9. The electric power source used with a vehicle as recited in claim 7, wherein the heat value detection circuit detects a heat value of the battery block based on a current flowing through the battery block.

10. The electric power source used with a vehicle as recited in claim 8, wherein the heat value detection circuit detects a heat value of the battery block in accordance with an integrated value of a current flowing through the battery block.

11. The electric power source used with a vehicle as recited in claim 7, wherein the heat value detection circuit detects a heat value of the battery block based on a temperature difference between the inlet side and outlet side of the cooling plate.

12. The electric power source used with a vehicle as recited in claim 7, wherein the heat value detection circuit detects a heat value of the battery block based on a current flowing through the battery block and on a temperature difference between the inlet side and outlet side of the cooling plate.

13. The electric power source used with a vehicle as recited in claim 3, wherein the controller has a dew formation sensor for detecting dew formed on the cooling plate, the dew formation sensor detecting the dew formed on the cooling plate and altering the preset temperature with which the temperature detected by the plate temperature sensor is compared.

14. The electric power source used with a vehicle as recited in claim 8, wherein the controller has a dew formation sensor for detecting dew formed on the cooling plate, the dew formation sensor detecting the dew formed on the cooling plate and altering first preset temperature with which the temperature detected by the plate temperature sensor is compared.

15. The electric power source used with a vehicle as recited in claim 8, wherein the controller has a dew formation sensor for detecting dew formed on the cooling plate, the dew formation sensor detecting the dew formed on the cooling plate and altering second preset temperature with which the temperature detected by the plate temperature sensor is compared.

16. The electric power source used with a vehicle as recited in claim 8, wherein the controller has a dew formation sensor for detecting dew formed on the cooling plate, the dew formation sensor detecting the dew formed on the cooling plate and altering the first preset temperature and the second preset temperature with which the temperature detected by the plate temperature sensor is compared.

17. An electric power source used with a vehicle, comprising:
a battery block composed of a rechargeable battery;
a cooling plate thermally coupled to the battery block to cool the battery;
a cooling mechanism for cooling the cooling plate; and
a controller for controlling the cooling mechanism to switch the cooling plate to a cooled state and an uncooled state,
wherein the cooling plate incorporates a cooling pipe through which a refrigerant is circulated, the cooling pipe is composed of a plurality of rows of parallel pipes interconnected in series and disposed inside the cooling plate, and a parallel pipe on an outlet side is disposed adjacent to a parallel pipe on an inlet side.

18. The electric power source used with a vehicle as recited in claim 17 wherein the cooling pipe is composed of four or more rows of parallel pipes.
